(19) United States
(12) Patent Application Publication
(10) Pub. No.: US 2008/0140477 A1
(43) Pub. Date: Jun. 12, 2008

(54) Online Community-Based Vote Security Performance Predictor

(76) Inventors: Avadis Tevanian, Los Altos Hills, CA (US); Mark Stevans, Sunnyvale, CA (US)

Correspondence Address: J. NICHOLAS GROSS, ATTORNEY, 2030 ADDISON ST., SUITE 610, BERKELEY, CA, 94704, US

(21) Appl. No.: 11/753,128

(22) Filed: May 24, 2007

Related U.S. Application Data
(60) Provisional application No. 60/803,069, filed on May 24, 2006.

(51) Int. Cl. G06Q 40/00; G06F 17/00; G06Q 30/00

(52) U.S. Cl. 705/7

(57) ABSTRACT

An Internet based community predictor for equities and other assets collects and compiles member votes and makes predictions based on overall community statistics. Individual votes are cast by members representing price predictions for particular equities over a target period. By relying on aggregated data it is possible to make more accurate forecasts for the behavior of other populations as well.

### RELATED APPLICATION DATA

The present application claims the benefit under 35 U.S.C. 119(e) of the priority date of Provisional Application Ser. No. 60/803069 filed May 24, 2006, which is hereby incorporated by reference.

### FIELD OF THE INVENTION

The present invention relates to electronic methods of collecting, facilitating and compiling prediction information from online users concerning the performance or time-behavior of items. The invention has particular applicability to Internet based social networking environments in which members can vote on the anticipated price of a security (or other time varying asset) over defined time periods.

### BACKGROUND

A few Internet sites, including that operated by Motley Fool® permit their users to predict the future prices of securities. Generally speaking, however, these sites only compile/permit their members to view the individual stock predictions of other members. These predictions can be sorted and ranked for purposes of identifying members with superior predictive capabilities, but they do not attempt to exploit the collective wisdom of a larger population. Examples of such types of systems can be seen in U.S. Publication Nos. 262118179; 26217994; and 27011073 which are hereby incorporated by reference herein.

While such prior art systems are useful, there is clearly a need for systems/methods which tap into a larger, aggregated intelligence of a collection of individuals for purposes of identifying latent opinions and securing more accurate forecasts of future behavior.

### SUMMARY OF THE INVENTION

An object of the present invention, therefore, is to overcome the aforementioned limitations of the prior art.

A first aspect of the invention concerns methods for predicting a future performance of an item, one of which comprises the following steps: specifying one or more items to be subjected to a community based vote; wherein the items include an item identifier parameter, a performance parameter, and an optional time related parameter; receiving votes from a population of persons in the community concerning the set of items; and generating a future performance prediction for the set of items based on the votes received from the population.

In a preferred embodiment the performance parameter is a change in a value of a financial instrument and the optional time related parameter is a predefined period of time. The future performance predictions can be disseminated as desired to different third parties, and can include predictions of varying degrees of accuracy, such that different predictions having different accuracies can be transferred to different respective third parties. An additional confidence rating for the future performance prediction can also be generated.

As another option, an additional step of monitoring and tabulating a prediction performance of individual voters can also be performed. In some instances all voters are given equal weight, while in other instances a voting weight of individual voters can be adjusted based on their prediction performance, or on a topic by topic basis. Depending ont the intended application, a community of voters can include subscribers and non-subscribers.

In a preferred approach an additional step of monitoring and tabulating a prediction performance of the entire community, or subsets/subgroups of colonies/tribes (voluntary or virtual) can also be performed. As with individuals, the prediction performance of the community can be tabulated on a topic basis, and/or a financial instrument basis.

The community of users can also present requests for additional items to be added to the set of items. Reminders and alerts can be sent to community members to induce voting, which can be provided through a client device having an Internet connection, or some other electronic device which does not have a direct Internet connection.

In some embodiments it may be desirable to employ collaborative filtering techniques, so that clusters of members within the community with similar voting/content interests can identified. Predictions for members of each cluster (for the entire community) for a particular item can then be derived from predictions made by other cluster members for the item.

Other preferred embodiments will generate profiles for each of the members, which profile can identify one of a voting behavior, a list of equities, category of equities, and/or a prediction accuracy. Based on this profile, an electronic advertisement for a member can be correlated for such member. Similarly, a search query and/or search result for a member which is correlated to a profile of such member can also be generated.

Another aspect of the invention pertains to methods of predicting a future performance of assets which are publicly traded in an exchange, one of which comprises the following steps: specifying at least one asset to be subjected to a community based vote; wherein the asset is characterized by a time varying price behavior; specifying a prediction target date for the asset; receiving votes from a population of persons in the community concerning the asset; wherein the votes specify a predicted value for a performance of the asset at the prediction target date; generating a graphical output region within an interface presented to a member which identifies an aggregated prediction performance for the prediction target date based on all members contributing votes for the asset; and generating a prediction rating that the asset will achieve the aggregated prediction performance based on an overall accuracy parameter associated with the community.

In preferred embodiments, the prediction rating is based on measuring historical accuracy data for the community and/or data for the asset.

The interface preferably presents additional information on community statistics for the assets, including most/least voted assets, assets having a highest/lowest prediction performance, and assets having a greatest/smallest prediction ratings change. A prediction rating includes an offset or bias which is calculated from the aggregated prediction performance and is provided to identify an expected deviation from such aggregated prediction performance.

Still another aspect of the invention concerns methods for predicting a future performance of assets which are publicly traded in an exchange, one of which includes the steps of: specifying at least one asset to be subjected to a community based vote; wherein the asset is characterized by a time varying price behavior; specifying a prediction target date for the asset; receiving votes from a population of persons in the community concerning the asset; wherein the votes specify a predicted value for a performance of the asset at the prediction target date; and generating a graphical output region within an interface presented to a member which identifies: i. an aggregated prediction performance for the prediction target date based on all members contributing votes for the asset; ii. a member prediction performance for the prediction target date for the asset; iii. historical data for a prior price behavior of the asset; and providing a vote entry field within the graphical output region which is adapted to permit the member to specify a predicted value for a performance of the asset.

In preferred embodiments the vote entry field permits a predicted value to be entered using a single click of a mouse or other input device. Also, the vote entry field preferably permits a numerical predicted value to be entered without requiring numerical input from the member.

The graphical output region can also present a performance rating achieved by the member. The interface can also present additional information on community statistics for the assets, including most/least voted assets, assets having a highest/lowest prediction performance, and assets having a greatest/smallest prediction ratings change. Furthermore, it can identify and highlight milestone/event dates related to the asset.

Other aspects of the invention are directed to systems and hardware which are configured with suitable software routines so that the above methods can be implemented and enjoyed by members over a network connection, preferably the Internet.

It will be understood from the Detailed Description that the inventions can be implemented in a multitude of different embodiments. Furthermore, it will be readily appreciated by skilled artisans that such different embodiments will likely include only one or more of the aforementioned objects of the present inventions. Thus, the absence of one or more of such characteristics in any particular embodiment should not be construed as limiting the scope of the present inventions. Moreover while described in the context of an equities price prediction system, it will be apparent to those skilled in the art that the present teachings could be used in any Internet based application that can benefit from a community prediction of some form for an item.

### DESCRIPTION OF THE DRAWINGS

FIG. 1 is an illustration of a main interface employed in the present invention that is adapted for assisting users/subscribers to set up and view selected/top ranked predictions for the future performance of items such as stocks/securities;

FIG. 2 is an illustration of a subscriber-specific interface employed in the present invention that is adapted for assisting users/subscribers to set up and view their individual predictions for the future performance of stocks/securities;

FIG. 3 is an illustration of a group-specific interface employed in the present invention that is adapted for assisting users/subscribers to set up and view group predictions for the future performance of stocks/securities;

FIG. 4 is a block diagram illustration of a preferred embodiment of a security performance prediction system implemented in accordance with the present invention.

### DETAILED DESCRIPTION

As noted above, prior to the present invention, stock picking has generally been in the realm of an individual stock picker that gains a reputation as a good predictor of price movements. These predictions can take on many forms, such as a price target made by an analyst, or a stock portfolio that is used to track performance of the picks.

The present invention allows any person to register/cast a vote, which is essentially an opinion, as to how an item, preferably a market security, will perform. The vote may apply to a stock, a stock option, a commodity, a market index, or any other type of financial instrument or asset. In other environments the invention could be used to provide predictions for the expected economic performance of other items which can be tracked objectively, such as the box office take for movies, sales of a song, sales of a particular product/service, number of website visitors, etc.

In the present invention, users (in preferred embodiment members) are encouraged to make as many predictions on as many securities as possible allowing creation of larger body of data which can be evaluated. This data can be analyzed and mined to generate community/crowd indicators—a representation of the collective predictions of the community. Other predictions can be gleaned as well.

The invention is based on the premise that every individual has a certain piece of knowledge that is relevant to a security, and can contribute relevant information. In some instances that knowledge may be deep, or in other cases it may just be superficial. When significant numbers of persons express their knowledge (in the form of positive or negative sentiment) one can correlate when the community is actually in some amount of agreement. This determination can help identify the future potential of a security. The community can identify trends in some cases well before the best analysts—and those trends are likely to correlate with the future performance of the underlying security.

To some extent the invention exploits the principle that the persons (analysts, brokers) who can most affect the price of an asset (i.e., by selling/buying or client recommendations) are also influenced by facts, events and opinions of third parties. By compiling, collecting and reviewing the community information the present invention can thus identify and predict what is the likely behavior of such market influencers as well.

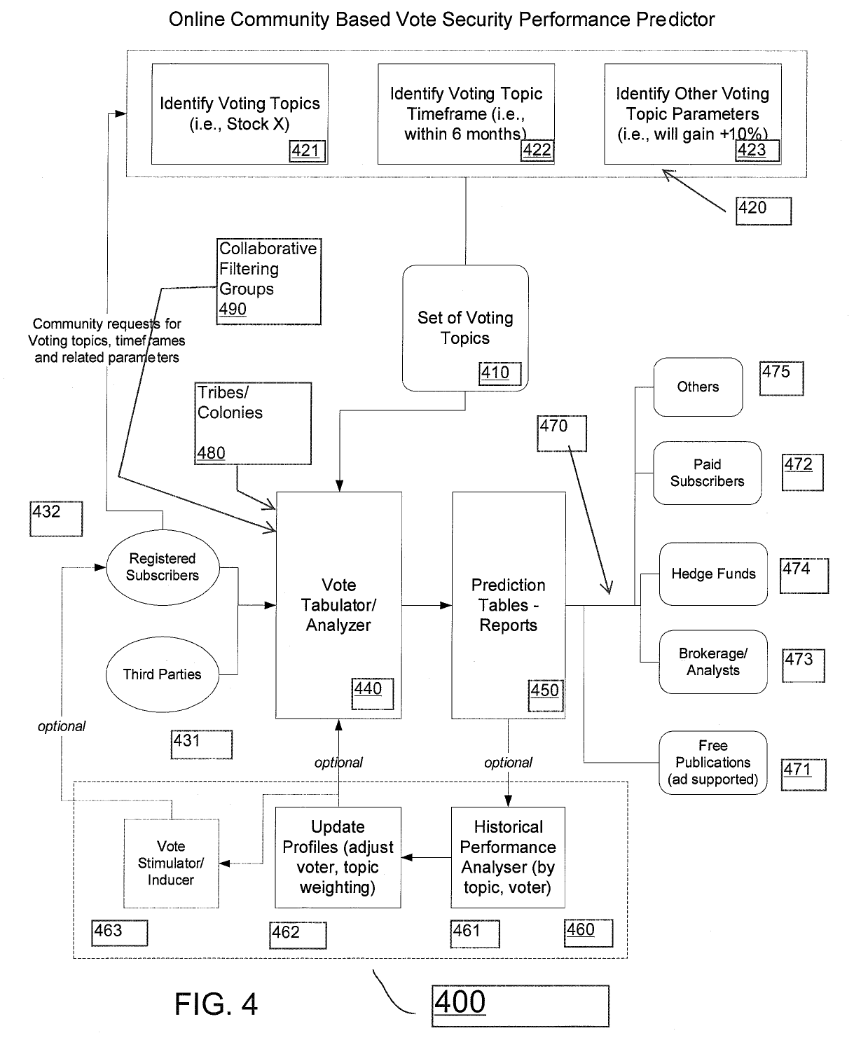

A simplified block diagram of the various components and inputs/outputs used in a preferred embodiment of security performance predictor system 400 is shown in FIG. 4.

Votes are structured, but there is variability in the structure. For example, as seen in FIG. 4 a set of voting topics 410 is compiled. This is done by identifying a voting topic and related parameters 420, including the identifier for the asset 421, a relevant time frame 422, and a prediction indicator 423. For example, a vote could be “security X will increase by 10%” or “this security will be up 5 points.” Similarly, a vote may encompass a timeframe. For example, a vote could be “within 6 months this security will be up at least 5%.” Other examples will be apparent to those skilled in the art from the present description.

The votes can be solicited from both members 430 (preferably registered subscribers) and third parties 431. The votes are tabulated and analyzed by one or more software routines 440 operating on an Internet accessible server. From this data, a series of predictions, in the form of tables, lists or reports 450 can then be generated. A graphical representation of the community's overall prediction can also be presented as explained below. This can be done by conventional averaging of the votes, by some kind of weighting, or a number of other alternative algorithms well-known in the art.

Moreover, in addition to presenting members with a graphical indication of the expected performance of the security on a particular target date based on an aggregated compilation of votes, the invention can also generate a prediction that such security will indeed achieve said aggregated prediction performance. This prediction can be based on an overall accuracy parameter associated with said community, again, which is preferably derived from analyzing historical data (or the track record) for the community as a whole for particular stocks or based on some other measurable metric.

In a preferred embodiment a voter's track past record is not used as a predictor of results (although using such data could be used for extra analysis it is not required for this invention). Each vote is given equal weighting regardless of such past performance. This causes the system to truly rely on the collective intelligence of all participants, with no favoritism toward a prior record.

Nonetheless, as shown in FIG. 4, in some applications additional options 460 can be implemented, so that historical performance of voters is in fact tabulated and updated periodically by a routine 461. Thus, in future votes, the subscriber/voter's profile is updated to reflect a higher/lower weighting by logic 462, to reflect an ongoing prescience score for the voter. In some applications this may lead to better community predictions because the overall weighting factor of better performing voters is higher.

Note that the subscriber's voting weight may be adjusted on a topic by topic basis if desired, so that a person may have different weightings depending on the security or topic involved. As such profiles are adjusted; they can be factored into future votes by the Vote Tabulator/Analyzer.

Furthermore the system may optionally track community performance by security or topic, so that evaluations can be made of the accuracy of the predictions on a more refined basis. From this data the system may scale or adjust requirements needed to render a published opinion or prediction. For example, it may be determined experimentally that the system is highly accurate in some domains, so that only a small number of votes are needed to render a valid prediction.

Similarly, in most cases it is probably desirable that no specific portfolio of stocks be created or tracked. Systems that use a portfolio as a base (created either from real funds or equivalent credits) may inherently limit and artificially constrain the intelligence of the collective as each participant must decide where to “invest” limited assets. With no portfolio, voters are able to vote as often as they want with no opportunity cost associated with any such vote, and without asset constraints.

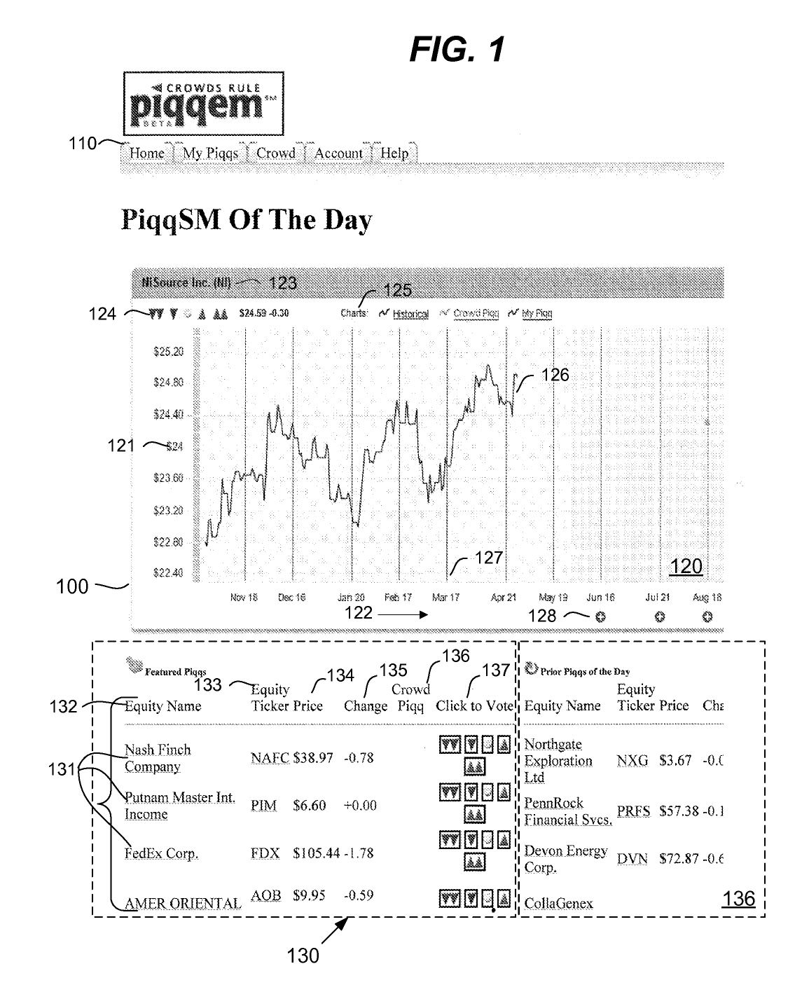

Votes may be collected in many ways, but the preferred embodiment uses an Internet website that allows users to see what votes are being taken and participate accordingly, and which is described in more detail in connection with FIGS. 1-3 below. In some environments, a home consumer device (such as a cable box, a television, a personal video recorder) may be used through a non-Internet communication connection to vote on a topic/security.

Users may also propose new votes to be taken. As noted above, in a preferred embodiment voters are registered users. This serves to generate a sense of accountability amongst the voters. It is also easier, of course, to track and maintain timely profiles. In another embodiment voters are not registered. This allows for completely anonymous voting. The two methods may or may not generate different results, but both are valid ways to collect the data and can be used to generate correlations. In some instances the two disparate populations can be tracked/evaluated separately and presented for comparison.

As noted above in a preferred embodiment all votes are treated equally and an overall stock prediction of the collective is generated (e.g., 70% predict rise, 20% predict no change, 10% predict decline). The quality of the prediction can be enhanced by taking into account the number of votes. For example, a prediction that is made by a very large number of voters (relatively speaking) may be of higher quality than one made by a very small number of voters. More complicated correlations can also be generated, e.g., weightings based on amount of price change.

As seen in FIG. 4 in some cases an optional vote stimulator/inducer routine 562 may be employed to encourage and solicit voting, particularly in cases where the system has determined that additional votes would improve prediction accuracy. The reminders can take any conventional form known in the art. For example, a vote stimulator routine may operate as a background task for a member, and as such person reviews stories, messages, etc. about particular securities, such routine could identify the names/symbols of companies/assets tracked by the community. A dialog box could then be opened to permit the member to make a pick of his/her choosing.

Once data is collected it is used to generate trading strategies for the underlying, or related, securities by another aspect of reporting routine 450. For example, one strategy is to buy a stock if voters vote for it to rise by a sufficient margin. Another strategy is to use the vote as a contrary indicator—if the vote is for a price rise the strategy could be to sell. More complicated and proprietary algorithms known in the art can also be used to analyze the votes to generate the predictions, reports, and buy, sell (or hold) strategies.

Collection and/or analysis of this data can be disseminated or used in a variety of ways as shown in outputs 470. In one embodiment 471 the data and resulting analysis is provided to users for no direct cost. The collection of the data and presentation of the results, however, could be annotated with paid advertising.

One form of output could see the data and resulting analysis provided for a fee to registered subscribers 472. In fact, some data may still be provided for free to any user (advertising supported) while other premium data is provided to any paid subscriber. Examples of possible premium data would be most recent predictions (as opposed to those released on a time delay) or predictions that surpass certain trigger levels (e.g., number of voters having voted or large correlations above certain thresholds).

In another form of output the data and resulting analysis is provided on a limited basis to professional managers of the underlying assets, such as hedge fund managers 473. The data and results are treated as highly valued information and distribution is limited.

In yet another form of output the data and resulting analysis is kept confidential and used as a form of proprietary information. This information is used for direct trading or in conjunction with a proprietary hedge fund, or related hedge funds 474.

None of these forms of distribution are mutually exclusive and in fact they can be combined. For example, data could be made available via a subscription to anyone wishing to pay while a hedge fund that trades solely on this information exists in parallel.

Another feature which could be implemented in the present invention is the concept of voluntary collections of member who are loosely designated as tribes or colonies 480. The tribes/colonies represent groups of individuals who voluntarily elect to band together and pool their knowledge for prediction/performance reasons. For example, a tribe could be a group of persons who are dedicated to a single asset, i.e. such as an individual security. Of course more than one asset could be associated with a tribe as well. Tribes could also be defined with reference to other parameters as well, such as geography (a San Francisco tribe) membership characteristics (an accountant tribe), age, or any other usable demographic.

The tribes/colonies could be self-governing, in the sense that they can define their own membership rules, any membership limits, assets to be voted upon, admission/ejection of members, etc. This feature of the invention allows for entertaining competition between groups of individuals, and can thus further stimulate the extraction of information from members. In some cases routine 450 could thus publish information ranking the relative performance not only of individuals, but of the respective tribes/colonies as well. Other characteristics and useful aspects of the tribe/colony feature could be varied in accordance with the particular requirements of any implementation.

In some implementations it may be desirable for routine 450 to compile analyses of members on its own who share certain interests, prediction behaviors, prediction accuracies, etc., to develop so-called “virtual” tribes. These virtual tribes could also be studied of course to glean additional prediction insights. For some applications it may be desirable to provide direct invitations/solicitations to members of common virtual tribes to facilitate their acquaintance with other such like minded/behaving members.

Another feature which could be utilized in the present invention involves collaborative filtering (CF) techniques. That is, the invention can make use of conventional CF algorithms which are extremely accurate in classifying persons into distinct groups based on their prior indicated preference ratings for items. These systems are extremely common and are used extensively in e-commerce, including at sites maintained at Netflix, Amazon, etc.

In the context of the present invention, CF routines could easily be adapted to develop CF groups 490. These CF groups are based on identifying a vote prediction by a particular member for a particular stock, analogous to the conventional mechanism by which such CF routines compile member ratings for movies, books, etc. Thus when a member givens a positive/negative prediction for a particular stock, this data can be captured and used to compare to other members to identify clusters of individuals with common voting characteristics.

By identifying other members like the subscriber, the invention can then solicit additional prediction information for other securities (rated by related members) which the subscriber has not yet rated. Based on the fact that the subscriber is correlated to the related members, the likelihood is greater that he/she will be motivated to provide a vote of some kind. This can further increase the participation rate.

Furthermore, in some instance the invention could not only alert the subscriber to the new voting opportunity, it could also provide a preliminary prediction of the subscriber's likely vote. This prediction may or may not be conveyed to the subscriber, depending on the application in question. While this feature has been implemented in other e-commerce applications, it has hitherto not been applied to the present domain.

Again, looking at the aspect of predictions across a larger group, the CF routines afford an opportunity to in effect, predict the predictions so to speak of the collective community. So in some cases the voting predictions by a limited number of members within a particular CF group can be used to extrapolate and act as a predictor for the behavior of other members in the CF group, and, by extension, the entire community can be predicted in this way from even a limited amount of data. Other data mining routines could also be used of course to glean associations and other useful membership data.

FIG. 1 illustrates a preferred embodiment of a main interface 100 employed in the present invention that is adapted for assisting users/subscribers to set up and view selected/top ranked predictions for the future performance of stocks/securities. The interface is implemented in a routine that is adapted so as to be presentable within a conventional web-browser or other similar Internet presentation software. Portions of the main interface (and the other interfaces discussed below), as well as data therein, can also be implemented as an RSS feed if desired.

As set up in main interface 100, the members are allowed to cast votes to give their predictions of a future value of an asset. For other applications of course the interface may present the outcome of an event. For example the score of a sports game may be predicted across multiple periods. The main interface 100 can allow members to make picks by any of a variety of possible mechanisms—through quick iconic entries, or if desired, through more elaborate graphical charting techniques. The choice of voting entry mechanism can be adjusted for any particular application.

The main interface 100 of FIG. 1 preferably contains the following components arranged in roughly three contiguous areas within a display window: a navigation bar 110; an asset/time chart display area 120; and a stock pick compilation area 130. While these areas are shown in the arrangement depicted in FIG. 1 it will be understood of course that they could be varied significantly depending on the overall desired functionality and aesthetic presentation. Other portions of main interface 100 could include other text/graphics content of course, and it will be understood that this is just intended to communicate some of the more material aspects presented to the user during a data session.

The asset/time chart portion 120 of the interface includes a number of useful features adapted to make it easy for a member to see data pertinent to the community impressions of a particular stock which is pre-selected and identified as the Piqq™ of the Day. The stock could be selected based on any desired criteria, including for example with reference to news stories or other criteria suggesting it would be of interest to the community. The main components of region 120 include: a price axis 121; a time axis 122; a stock identifier 123; a quick pick entry area 124 (which can be used for entering quick picks as explained below); a chart legend area 125 (which shows the labels used for three types of data in three separate colors for ease of comparison—namely, a historical asset value; a crowd (group/community) prediction; and a member/personal prediction); a chart 126 identifying such values; and a set of date/event milestone markers 127. The individual milestone markers can be opened/closed by using icon 128 in conventional fashion.

While not specifically shown in FIG. 1, an aggregated prediction rating can also be specified in region 120 which identifies a confidence level or expectation value that the community prediction is accurate. Additional statistical data could be derived over time to measure and identify community biases (positive and negative) for particular securities. These biases could also be overlaid/presented within region 120 so that the system can present its interpretation or prediction based on some offset of the community based prediction. Future price predictions can also be projected for later target dates based on the data provided for the current open target dates. Again those skilled in the art will appreciate that the actual visual characteristics of region 120 can be tailored to any specific application.

For purposes of the present discussion, a “target date” is a date at which a predicted price is supposed to be reached. For convenience, in a stock prediction embodiment, these dates are configured to fall on futures options expiration dates. A “closed” target date is a date for which predictions may no longer be entered. An “expired” target date refers to a past target date. Finally, an “open” target date is a date in the future, usually at least 30 days or more for which predictions may be entered or edited for it.

Thus in a preferred embodiment the member makes predictions for dates/milestones (target dates) 127 which are pre-selected by a vote tabulator/analyzer routine 440 (FIG. 4). For an application involving stocks the dates are typically pegged to correspond to the end of trading of most options—the third Friday of each month. It will be understood that such dates/milestones would be different for different types of applications.

Region 130 of main interface 100 includes textual descriptions and compilations relating to other featured stocks, which, again, could be derived with similar considerations as used for the main pick stock presented in region 120. The main components of region 130 include several data fields, most of which are self-explanatory: a stock identifier field 131 presented under an equity name column 132; an equity sticker column 133; a price column 134; a price change column 135; a crowd (group/community) pick indicator column 136; and a vote/prediction quick pick column 137.

Vote/prediction column 137 contains a mechanism for quickly allowing a member to easily select one of 5 predefined indicators for predicting the price of equity over the next target date period. These 5 predefined indicators can be selected to indicate the member's vote as follows: strongly positive sentiment (double up arrow); positive sentiment (single up arrow); neutral sentiment (disc); negative sentiment (single down arrow); strongly negative sentiment (double down arrow). The indicators can also be color coded as desired. It should be noted that when data is available, and the crowd pick entry 136 correlates to one of such predetermined predicted values the appropriate indicator can be used in such row for such equity. Portion 136 is dedicated to presenting information on stocks previously selected as Piqq of the Day. As with the other regions of interface 100 those skilled in the art will appreciate that the actual visual characteristics of region 130, including the particular choice of icons/functions can be tailored to suit any specific application. For example the icons could be explicitly labeled as corresponding to different percentages (i.e., 30 10, +5, 0, −5, −10 or some other range) Further as alluded to above the entry of votes can be effectuated through other means, including graphical entry techniques, depending on the desired effect/functionality.

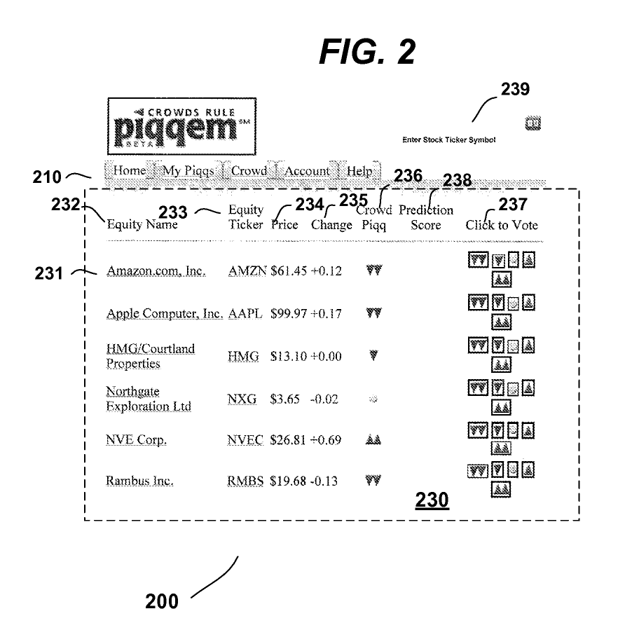

FIG. 2 is an illustration of a subscriber-specific interface 200 employed in the present invention that is adapted for assisting users/subscribers to set up and view their individual predictions for the future performance of stocks/securities. This interface is selected from navigation area 110 (FIG. 1—my piqqs). In a preferred embodiment this page displays a list containing each equity for which the member has ever entered a prediction.

The main components of this interface include a number of elements which are related to those already discussed above. Unless otherwise indicated, like reference numerals are intended to refer to like elements to those shown in connection with region 130 (FIG. 1). Thus region 230 has the following main components: a stock identifier field 231 presented under an equity name column 232; an equity sticker column 233; a price column 234; a price change column 235; a crowd (group/community) pick indicator column 236; and a vote/prediction quick pick column 237.

The only difference for this particular interface is the fact that it also includes an additional data field for a prediction score 138 associated with the particular subscriber's prediction for a particular equity. In a preferred embodiment, for any equity for which expired predictions were entered by member, this column displays a metric indicating the relative accuracy of the predictions. A score of 100 for example indicates that the actual prices exactly matched all predictions. Other variations will be apparent to those skilled in the art.

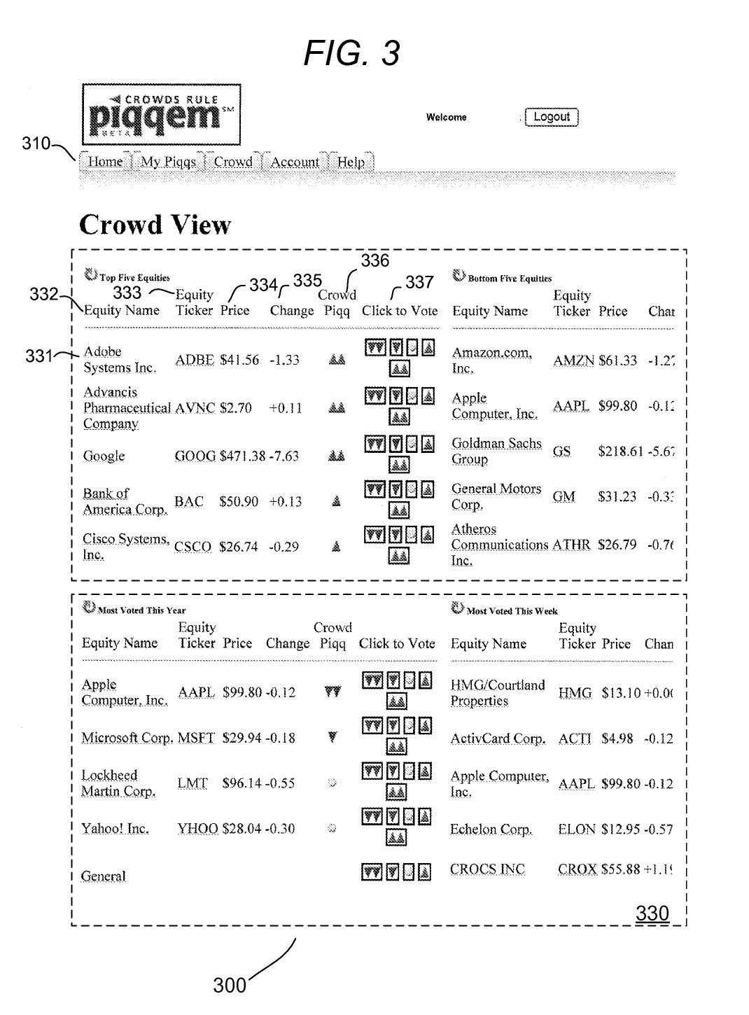

FIG. 3 is an illustration of a group-specific interface 300 employed in the present invention that is adapted for assisting users/subscribers to set up and view group predictions for the future performance of stocks/securities. This interface is selected from navigation area 110 (FIG. 1—crowd). In a preferred embodiment this page displays a number of tables, including a list of equities with the highest/lowest crowd predictions for the next open target date, as ranked by the predicted percentage change in price. Other tables list the equities for which the greatest number of user predictions has been entered, where each different target date is considered a separate prediction.

The main components of this interface include a number of elements which are related to those already discussed above. Unless otherwise indicated, like reference numerals are intended to refer to like elements to those shown in connection with regions 130 (FIG. 1) and 230 (FIG. 2). Thus region 330 has the following main components: a stock identifier field 331 presented under an equity name column 332; an equity ticker symbol column 333; a price column 334; a price change column 335; a crowd (group/community) pick indicator column 336; and a vote/prediction quick pick column 337.

Region 130 basically identifies four different tables: 1) a first table showing the n (in this instance n=5) equities having a highest community wide positive prediction rating; 2) a second table showing the n lowest highest community wide positive prediction rating; 3) a third table showing the m most frequently voted equities over the course of a year; and finally a fourth table showing the m most frequently voted equities over the course of a more recent period, such as a week. Other tables could be included, such as with lists identifying greatest changes (positive and negative) in community sentiment. In some instances it may be preferable to increase the size of the tables and display them across multiple independent pages. Again other variations for interface 300 will be apparent to those skilled in the art.

As with any other website that attracts a substantial number of visitors, the present invention could also be used to interface with an advertising delivery system (not shown) to deliver relevant advertising to members of the community. While conventional ad delivery systems are typically based on some form of content-based analysis, the present invention can extend this principle to include user voting profiles/histories as part of the determination process for delivering a relevant ad. Thus a user voting profile could be classified into different types of personalities, categories, etc., and be used for purposes of targeted advertising. For example a member may be classified as a stock bull, a bear, conservative, aggressive, a prolific predictor, a measured predictor, etc., based on some form of psychological examination of the user's behavior. The member's objective prediction accuracy could be another factor considered as well, so that more experienced/accurate members could be associated with one type of advertising, while less experience/accurate members could be targeted with other types of advertising. For example a variety of investing literature may be advertised on the site, with the prediction accuracy directly influencing the sophistication level of the materials displayed as ads. Another factor which could be considered is the type/identity of equities/assets for which the voter tends to make predictions. For example persons who tend to predict equities in a particular area (utilities, high technology, consumer goods, etc.) might have their advertising directly correlated to such interests as gleaned from the user's prediction list.

Search engines are now also using user behavior/activities/profiles as a form of filtering/tailoring search queries/results, and the above factors could be used in such fashion as well.

Thus the above parameters, including the voting profile and/or prediction/profile could be used alone or combined of course with other relevant parameters (including other profile data and page content) as desired to influence both advertising and search engine functionality. In all such cases the user profiles could be arranged along some convenient spectrum as well to match different types of ads in inventory. Other variations on advertising will be apparent to those skilled in the art.

It will be understood that the invention is not limited to any particular hardware implementation in this respect, and that such components can be implemented preferably by one or more software routines and databases executing (or residing) on a combination of hardware platforms, including conventional Internet servers. Some aspects of the invention may be implemented in part on client side devices, such as a personal computer, a cellphone, PDA, consumer electronic device, etc. Again those skilled in the art will appreciate that the particular hardware is not critical to the operation of the invention.

The above descriptions are intended as merely illustrative embodiments of the proposed inventions. It is understood that the protection afforded the present invention also comprehends and extends to embodiments different from those above, but which fall within the scope of the present claims.

What is claimed is:

1. A method for predicting a future performance of an item comprising:
specifying one or more items to be subjected to a community based vote;
wherein said items include an item identifier parameter, a performance parameter, and an optional time related parameter;
receiving votes from a population of persons in the community concerning said set of items;
generating a future performance prediction for said set of items based on said votes received from said population.

2. The method of claim 1, wherein said item is a financial instrument.

3. The method of claim 1, wherein said performance parameter is a change in a value of a financial instrument.

4. The method of claim 1, wherein said optional time related parameter is a predefined period of time.

5. The method of claim 1, further including a step: processing requests from said community for additional items to be added to said set of items.

6. The method of claim 1, further including a step: disseminating said such future performance prediction to one or more third parties.

7. The method of claim 6, wherein said future performance predictions include predictions of varying degrees of accuracy, such that different predictions having different accuracies can be transferred to different respective third parties.

8. The method of claim 1, further including a step: monitoring and tabulate a prediction performance of individual voters.

9. The method of claim 8, wherein a voting weight of individual voters is adjusted based on their prediction performance.

10. The method of claim 9, wherein said voting weight is adjusted on a topic by topic basis.

11. The method of claim 1, wherein said community includes subscribers and non-subscribers.

12. The method of claim 1, wherein each vote from persons in the community is weighted equally.

13. The method of claim 1, further including a step: monitoring and tabulating a prediction performance of the community.

14. The method of claim 13, wherein said prediction performance of the community is tabulated on a topic basis, and/or a financial instrument basis.

15. The method of claim 1, further including a step: providing reminders and alerts to community members to induce voting.

16. The method of claim 1, wherein said votes are provided through a client device having an Internet connection.

17. The method of claim 1, wherein said votes are provided through an electronic device which does not have a direct Internet connection.

18. The method of claim 1 further including a step: providing one or more colonies within said community, wherein each colony is a voluntary association of members from said community.

19. The method of claim 18, wherein a prediction performance of the one or more colonies is tabulated on a topic basis, and/or a financial instrument basis.

20. The method of claim 18 further including a step: wherein said colonies each include a set of self-defined regulations for admitting and/or maintaining colony members.

21. The method of claim 1 further including a step: providing one or more clusters of members within said community, wherein each cluster is calculated based on a collaborative filtering algorithm.

22. The method of claim 21, wherein predictions for members of each cluster for a particular item are derived from predictions made by other cluster members for said item.

23. The method of claim 21, wherein community based predictions for a particular item are derived from predictions made selected members in said clusters for said particular item.

24. The method of claim 21, wherein said clusters are analyzed to identify other items which members can be prompted for contributing votes.

25. The method of claim 1, further including a step: generating a confidence rating for said future performance prediction.

26. The method of claim 1 further including a step: generating additional future performance predictions for said set of items for later dates than those specified in said votes without requiring additional voting from said members for said later dates.

27. The method of claim 1 further including a step: calculating one or more virtual colonies within said community, wherein each virtual colony is determined by a computing system based on voting behavior.

28. The method of claim 1 further including a step: generating a profile for each of the members, wherein said profile identifies one of a voting behavior, a list of equities, category of equities, and/or a prediction accuracy.

29. The method of claim 28 further including a step: generating an electronic advertisement to a member which is correlated to a profile of such member.

30. The method of claim 28, further including a step: generating a search query and/or search result for a member which is correlated to a profile of such member.

31. The method of claim 1, where the statistical weight of individual votes at any point in time is adjusted based upon the time that has elapsed since the vote was created.

32. The method of claim 1, where the statistical weight of individual votes at any point in time is adjusted based upon the time remaining until a target date associated with such votes.

33. A method for predicting a future performance of assets which are publicly traded in an exchange comprising:
specifying at least one asset to be subjected to a community based vote;
wherein said asset is characterized by a time varying price behavior;
specifying a prediction target date for said asset;
receiving votes from a population of persons in the community concerning said asset;
wherein said votes specify a predicted value for a performance of said asset at said prediction target date;
generating a graphical output region within an interface presented to a member which identifies an aggregated prediction performance for said prediction target date based on all members contributing votes for said asset;
generating a prediction rating that said asset will achieve said aggregated prediction performance based on an overall accuracy parameter associated with said community.

34. The method of claim 33 wherein said prediction rating is based on measuring historical accuracy data for said community.

35. The method of claim 33 wherein said historical accuracy data is based on data for said asset.

36. The method of claim 33, wherein said interface presents additional information on community statistics for the assets, including at least one or more of the following: most/least voted assets; assets having a highest/lowest prediction performance; assets for which the predictions vary the most or least within the community; and/or assets having a greatest/smallest prediction ratings change.

37. The method of claim 33, wherein said prediction rating includes an offset or bias which is calculated from said aggregated prediction performance and provided to identify an expected deviation from such aggregated prediction performance.

38. A method for predicting a future performance of assets which are publicly traded in an exchange comprising:
specifying at least one asset to be subjected to a community based vote;
wherein said asset is characterized by a time varying price behavior;
specifying a prediction target date for said asset;
receiving votes from a population of persons in the community concerning said asset;
wherein said votes specify a predicted value for a performance of said asset at said prediction target date;
generating a graphical output region within an interface presented to a member which identifies:
an aggregated prediction performance for said prediction target date based on all members contributing votes for said asset;
a member prediction performance for said prediction target date for said asset;
historical data for a prior price behavior of said asset;
providing a vote entry field within said graphical output region which is adapted to permit said member to specify a predicted value for a performance of said asset.

39. The method of claim 38 wherein said vote entry field permits a predicted value to be entered using a single click of a mouse or other input device.

40. The method of claim 38 said vote entry field permits a numerical predicted value to be entered without requiring numerical input from said member.

41. The method of claim 38 wherein said graphical output region also presents a performance rating achieved by said member.

42. The method of claim 38, wherein said interface presents additional information on community statistics for the assets, including at least one or more of the following: most/least voted assets; assets having a highest/lowest prediction performance; assets for which the predictions vary the most or least within the community; and/or assets having a greatest/smallest prediction ratings change.

43. The method of claim 38 wherein said interface also presents additional event dates related to said asset.

44. An electronic system for predicting a future performance of an item comprising:
one or more software routines executing on a server computing device, said one or more software routines being configured to:
a) specify a set of items to be subjected to a community based vote;
wherein said items include an item identifier parameter, a performance parameter, and an optional time related parameter;
b) receive votes from a population of persons in the community concerning said set of items;
c) generate a future performance prediction for said set of items based on said votes received from said population.

45. An electronic system for predicting a future performance of an item comprising:
one or more software routines executing on a server computing device, said one or more software routines being configured to:
a) specify at least one asset to be subjected to a community based vote;
wherein said asset is characterized by a time varying price behavior;
b) specify a prediction target date for said asset;
c) receive votes from a population of persons in the community concerning said asset;
wherein said votes specify a predicted value for a performance of said asset at said prediction target date;
d) generate a graphical output region within an interface presented to a member which identifies an aggregated prediction performance for said prediction target date based on all members contributing votes for said asset;
e) generate a prediction rating that said asset will achieve said aggregated prediction performance based on an overall accuracy parameter associated with said community.

46. An Internet-based electronic system for predicting a future performance of an item comprising:
one or more software routines executing on a server computing device, said one or more software routines being configured to:
a) specify at least one asset to be subjected to a community based vote;
wherein said asset is characterized by a time varying price behavior;
b) specify a prediction target date for said asset;
c) receive votes from a population of persons in the community concerning said asset;
wherein said votes specify a predicted value for a performance of said asset at said prediction target date;
d) generate a graphical output region within an interface presented to a member which identifies:
i. an aggregated prediction performance for said prediction target date based on all members contributing votes for said asset;
ii. a member prediction performance for said prediction target date for said asset;
iii. historical data for a prior price behavior of said asset;
e) provide a vote entry field within said graphical output region which is adapted to permit said member to specify a predicted value for a performance of said asset.
